(19) United States
(12) Patent Application Publication
(10) Pub. No.: US 2010/0241423 A1
(43) Pub. Date: Sep. 23, 2010

(54) SYSTEM AND METHOD FOR FREQUENCY TO PHASE BALANCING FOR TIMBRE-ACCURATE LOW BIT RATE AUDIO ENCODING

(76) Inventors: Stanley Wayne Jackson, Santa Cruz, CA (US); Jay T. Dresser, San Jose, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/406,889

(22) Filed: Mar. 18, 2009

(51) Int. Cl. G10L 11/04; G10L 19/00

(52) U.S. Cl. 704/206; 704/230; 704/E19.001; 704/E11.006

(57) ABSTRACT

Embodiments of a system and method for encoding audio data have been described. In one embodiment, the method includes transforming frequency domain data in a plurality of signal windows of an audio dataset from a cosine/sine format to a magnitude/cosine/sine format. The magnitude/cosine/sine format disproportionately represents a magnitude of the frequency domain data over a phase of the frequency domain data. The above transformation may be a pre-processing stage of vector quantization usable to produce a codebook.

### BACKGROUND

1. Field of the Invention

This invention relates generally to the field of data processing systems. More particularly, the invention relates to a system and method for frequency-to-phase balancing for timbre-accurate low bit rate audio encoding.

2. Description of the Related Art

Today, audio playing devices are widely used by consumers. In addition to conventional non-portable audio devices (e.g., stereo system, etc.), many people use portable electronic devices capable of playing audio as well, such as personal digital assistants (PDA's), portable media players, digital cameras, cellular telephones, wireless devices, and/or an electronic device with multiple functions (e.g., a PDA with cell phone abilities).

Many conventional electronic devices allow a user to play audio in formats such as MP3, advanced audio coder (AAC), AAC-plus, Windows® media audio (WMA), adaptive transform acoustic coding (ATRAC), ATRAC3, and ATRAC3Plus. Many portable electronic devices have processing, bandwidth, memory, or power consumption limitations that make playing, receiving, and/or storing audio in such formats difficult or even impossible. For example, many conventional cellular phones are unable to play high bit rate ringtones.

As a result, audio is converted into a low bit rate format in order for many devices with limitations in processing, storage, and/or bandwidth to be able to play the audio. One problem with the playing of low bit rate audio is that the quality of the audio is significantly diminished and perceived as substandard by users of the device. Some techniques in enhancing the perceptual quality of low bit rate compressed audio data are disclosed in a co-pending U.S. patent application Ser. No. 12/014,646, filed Jan. 15, 2008, entitled “System and Method for Enhancing Low Bit Rate Compressed Audio Data.” One factor contributing to the lower quality of the audio is the distortion of sound resulting from the potential cancellation of the magnitude of conventional cosine/sine representation. Typically, when transforming audio data from time domain into frequency domain using Discrete Cosine Transform (DCT), frequency bins are in the form of paired cosine/sine coefficients. Each cosine/sine pair represents both the power magnitude and periodic phase for a single constituent frequency. When this cosine/sine frequency is subjected to a vector quantization process as a stage of information reduction in audio compression, the conventional cosine/sine representation has the effect of magnitude cancellation if input cosine/sine bins are out of phase. In other words, accurate reproduction of frequency power is sacrificed for a more accurate representation of phase. Because frequency is significantly more important than phase in psychoacoustic terms, codebooks produced from the conventional cosine/sine audio data representation may sound distorted.

### SUMMARY

Embodiments of a system and method for encoding audio data are described. In one embodiment, the method includes transforming frequency domain data in a set of windows of an audio dataset from a cosine/sine format to a magnitude/cosine/sine format. The magnitude/cosine/sine format disproportionately represents a magnitude of the frequency domain data over a phase of the frequency domain data. The above transformation may be a pre-processing stage of vector quantization usable to produce a codebook.

### BRIEF DESCRIPTION OF THE DRAWINGS

A better understanding of the present invention can be obtained from the following detailed description in conjunction with the following drawings, in which:

FIG. 1 illustrates one embodiment of a method to encode audio data.

FIG. 2A illustrates one embodiment of a magnitude/cosine/sine transformer.

FIG. 2B illustrates one conventional representation of DCT time-domain data as paired cosine/sine coefficients.

FIG. 2C illustrates one conventional representation of a cosine/sine pair.

FIG. 2D illustrates one embodiment of a magnitude/cosine/sine representation of audio data.

FIG. 3 illustrates one embodiment of a system to process audio data.

FIG. 4 illustrates one embodiment of a system in which the present invention may be implemented.

FIG. 5 illustrates an example computing system for implementing some embodiments of the magnitude/cosine/sine transformer of FIG. 2A.

### DETAILED DESCRIPTION

The following description describes embodiments of a system and method for frequency to phase balancing for timbre-accurate low bit rate audio encoding. In some embodiments, frequency domain data in a set of windows of an audio dataset is transformed from a cosine/sine format to a magnitude/cosine/sine format before vector quantization is applied to produce codebooks. The magnitude/cosine/sine format disproportionately represents a magnitude of the frequency domain data over a phase of the frequency domain data. As such, the magnitude may not be canceled during vector quantization, even if the input cosine/sine bins are out of phase, and the resultant sound generated from the codebooks produced is thus more timbre-accurate.

Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Some portions of the detailed descriptions below are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a machine-readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required operations. The required structure for a variety of these systems will appear from the description below. In addition, the present invention is not described with reference to any particular programming language. It will be appreciated that a variety of programming languages may be used to implement the teachings of the invention as described herein.

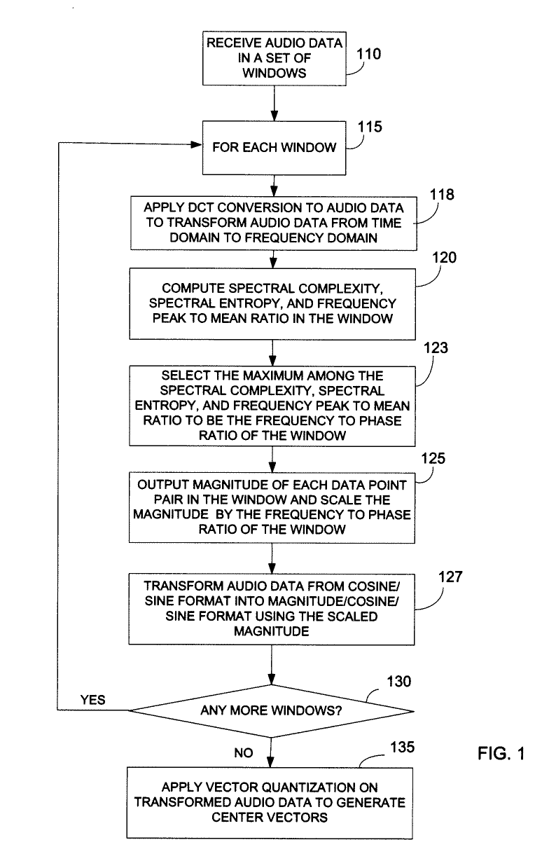

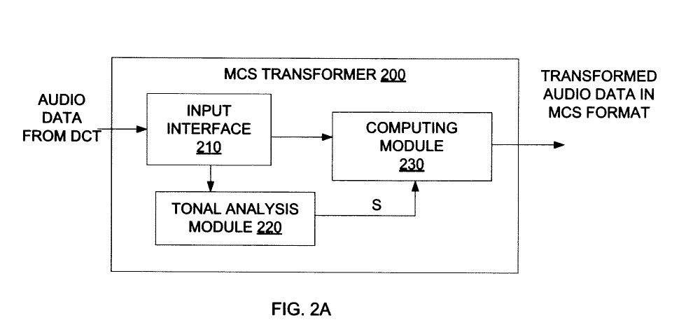

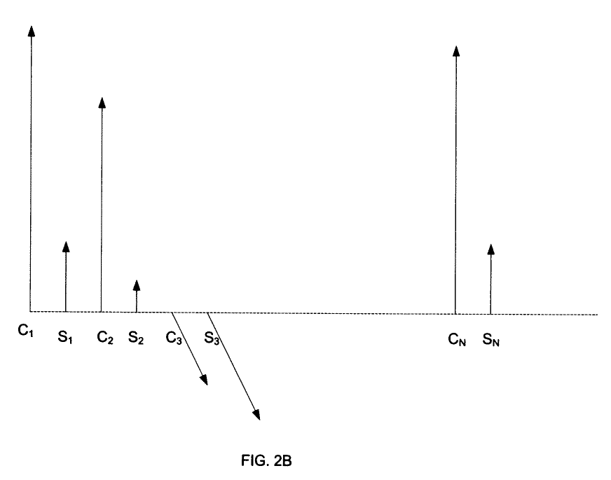

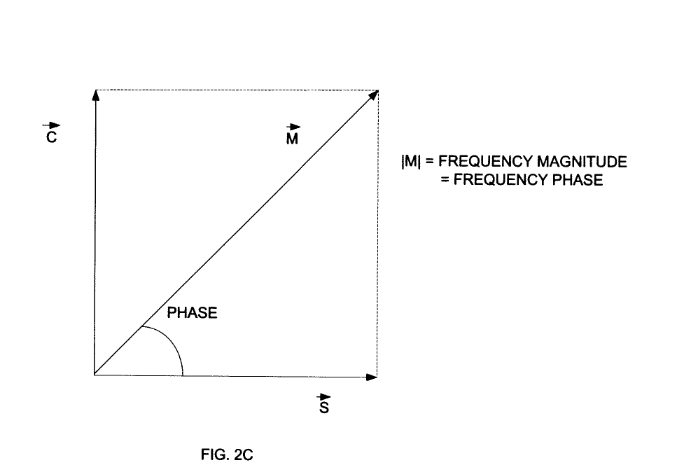

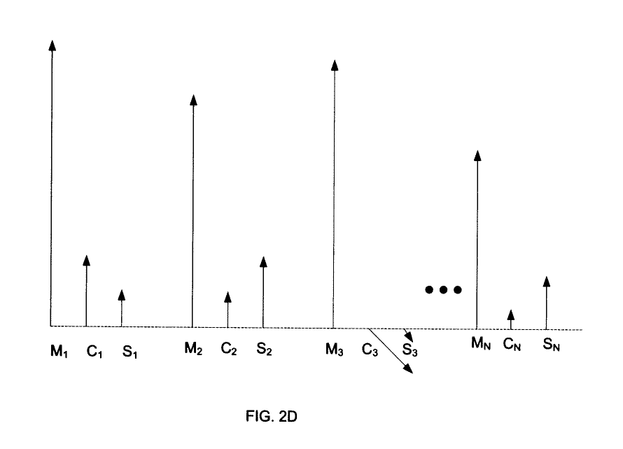

FIG. 1 illustrates one embodiment of a method to encode audio data. The method may be performed by processing logic that may comprise hardware (e.g., circuitry, dedicated logic, programmable logic, microcode, etc.), software (such as instructions run on a processing device), firmware, or a combination thereof. For instance, the method may be performed by the magnitude/cosine/sine transformer 200 illustrated in FIG. 2A in some embodiments.

Initially, processing logic receives audio data in a set of overlapping time-based windows (processing block 110). The audio data may have been smoothed by either the Sine Function or Hanning Function and processed by discrete cosine transform (DCT), and thus, is represented as a sum of cosine functions and sine functions oscillating at different frequencies. One should appreciate that other functions may be used in different embodiments. The frequency bins are in the form of paired cosine/sine coefficients. Before encoding the audio data received, processing logic first determines a frequency to phase ratio (S) for each window.

For each window, processing logic applies discrete cosine transform (DCT) to the audio data to convert the audio data from time domain into frequency domain (processing block 118). In some embodiments, processing logic performs tonal analysis in a window to determine the frequency to phase ratio of the window. For instance, processing logic may compute various attributes of the data, including spectral complexity, spectral entropy, and a frequency peak to mean ratio in the window (processing block 120). More details on spectral complexity, spectral entropy, and frequency peak to mean ratio are discussed below. Then processing logic selects the maximum among the spectral complexity, spectral entropy, and frequency peak to mean ratio to be the frequency to phase ratio of the window (processing block 123). Alternatively, a subset of the above attributes and/or different attributes may be used to determine the frequency to phase ratio in other embodiments.

In an alternate embodiment, instead of performing tonal analysis in each window, processing logic may perform tonal analysis on a subset of the windows. For example, processing logic may perform tonal analysis in only the first window to determine the frequency to phase ratio, and then processing logic may apply the same frequency to phase ratio to all windows. In another example, processing logic may perform tonal analysis in every few windows, say every five windows. Then the frequency to phase ratio determined in the first window is applied to the first five windows, the frequency to phase ratio determined in the sixth window is applied to the next five windows, and so on.

In another alternate embodiment, processing logic may select a fixed frequency to phase ratio to be used in all windows without performing tonal analysis. For example, processing logic may select a value from a predetermined range of values to be the fixed frequency to phase ratio. Based on experimental observation in some embodiments, the range of real numbers from greater than zero (0.0) to twenty (20.0), non-inclusive of zero (i.e., (0.0, 20.0]), is deemed satisfactory in general. Thus, a value between 0.0 and 20.0 may be selected as the fixed frequency to phase ratio for all windows. Note that the above approaches are merely some exemplary ways to determine the frequency to phase ratio, and different approaches may be used in other embodiments.

After determining the frequency to phase ratio in a window, processing logic outputs a magnitude value for each cosine/sine pair and scales the magnitude for each data point pair in the window by the frequency to phase ratio of the window (processing block 125). Then processing logic transforms the audio data into a magnitude/cosine/sine (Mcs) format using the scaled magnitude (processing block 127). The resultant data representation, thus, disproportionately emphasizes magnitude over phase. In other words, the transformed data is stretched along the magnitude dimensions.

After transforming the audio data in the window, processing logic checks if there are any more windows to be processed (processing block 130). If there is at least one more window, then processing logic returns to processing block 115 to repeat the above operations. If there are no more windows, then processing logic transitions to processing block 135.

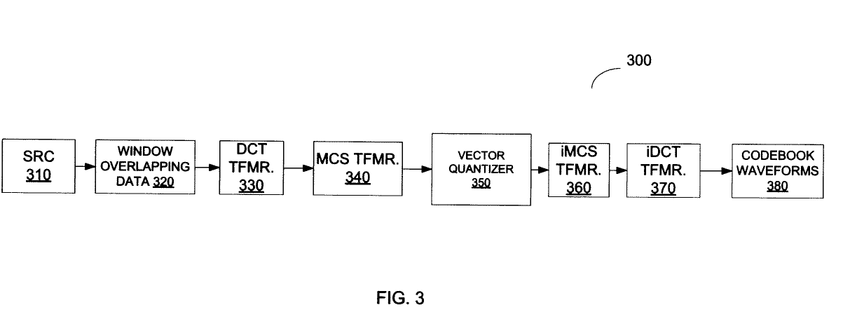

After the audio data has been converted to the Mcs format, processing logic applies vector quantization on the transformed audio data to generate center vectors (processing block 135), which may be further processed to generate codebook waveforms as further discussed below with reference to FIG. 3. Vector quantization generally allows modeling of probability density functions by the distribution of the prototype vectors of the audio data. Because the audio data has been stretched along the magnitude dimensions by the Mcs transformation, the magnitudes may not be cancelled even if the input cosine/sine bins are out of phase. Thus, the frequency power of the audio data can be reproduced more accurately. In psychoacoustic terms, frequency is significantly more important than phase because accurate reproduction of frequency helps to reduce distortion of sound. Thus, the Mcs transformation discussed above improves timbre-accuracy of the sound generated from the codebooks produced.

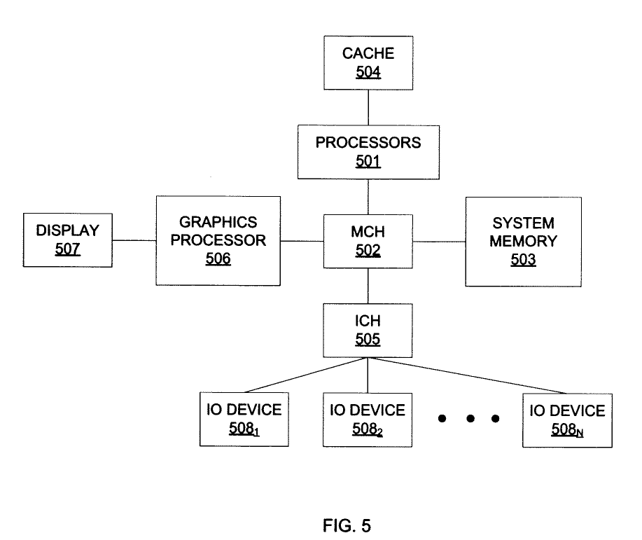

FIG. 2A illustrates one embodiment of a magnitude/cosine/sine transformer (Mcs transformer). The Mcs transformer 200 may be implemented by various computing systems, such as servers, personal computers, etc. One exemplary computing system usable in some embodiments to implement the Mcs transformer is illustrated in FIG. 5.

In some embodiments, the Mcs transformer 200 includes an input interface 210, a tonal analysis module 220, and a computing module 230. A first output of the input interface 210 is coupled to a first input of the computing module 230, and a second output of the input interface 210 is coupled to an input of the tonal analysis module 220. An output of the tonal analysis module 220 is coupled to a second input of the computing module 230.

In operation, the input interface 210 receives input audio data in a set of windows (also referred to as signal windows) generated from discrete cosine transform (DCT). The frequency bins of the data are in the form of paired cosine/sine coefficients, which are denoted as cᵢ and sᵢ in FIG. 2B, where i ranges from one (1) to N. Each pair of cosine/sine coefficients represents both the power magnitude (M) and periodic phase (φ) for a single constituent frequency as illustrated in FIG. 2C. The magnitude (M) of the perpendicular vector sum of the coefficients is the power magnitude at the given frequency. The input interface 210 forwards the audio data to both the tonal analysis module 220 and the computing module 230.

In some embodiments, the tonal analysis module 220 analyzes the audio data in each window to determine a frequency to phase ratio for the respective window. The tonal analysis module 220 analyzes various attributes of the audio data in the respective window, including spectral complexity, spectral entropy, and frequency peak to mean ratio. Given a peak-to-peak normalized spectrographic representation of input window i, the tonal analysis module 220 may approximate the “raw” complexity Cᵢ of the window as the square of sum of the differences between adjacent bins using the following equation:

$${C}_{i} = {( {\sum }_{n = 1}^{N - 1} \vert {b}_{C , n} - {b}_{C , n + 1} \vert )}^{2}$$

Given a peak-to-peak normalized spectrographic representation of input window i, the tonal analysis module 220 may approximate the spectral entropy Eᵢ of the window using the following equation:

$${E}_{i} = - {\sum }_{n = 1}^{N} p ( {b}_{n} ) {log}_{10} ( p ( {b}_{n} ) )$$

Given a peak-to-peak normalized spectrographic representation of input window i, the tonal analysis module 220 may compute a peak frequency to mean ratio Fᵢ of the window as the maximum bin value over the mean of all bin values using the following equation:

$${F}_{i} = \frac{{b}_{max}}{( {\sum }_{n = 1}^{N} {b}_{n} ) \text{/} N}$$

Given an arbitrary real number range [Rₘᵢₙ, Rₘₐₓ], the tonal analysis module 220 may normalize and translate all values of C, E, F to this range using the following equations:

$${C}_{i}^{′} = \frac{( {C}_{i} - {C}_{min} )}{( {C}_{max} - {C}_{min} )} ( {R}_{max} - {R}_{min} ) - {R}_{min}$$

$${E}_{i}^{′} = \frac{( {E}_{i} - {E}_{min} )}{( {E}_{max} - {E}_{min} )} ( {R}_{max} - {R}_{min} ) - {R}_{min}$$

$${F}_{i}^{′} = \frac{( {F}_{i} - {F}_{min} )}{( {F}_{max} - {F}_{min} )} ( {R}_{max} - {R}_{min} ) - {R}_{min}$$

In general, the frequency-to-phase ratio Sᵢ is a real number greater than zero (0). Based on experimental observation in one embodiment, the real number range (0.0, 20.0] (non-inclusive of zero) is found to be satisfactory. In other embodiments, the range of the frequency-to-phase ratio may have a different upper limit. For each input signal window i, the frequency to phase ratio Sᵢ is set to be the maximum of (Cᵢ, Eᵢ, Fᵢ) in some embodiments.

Note that variations of the above approach or other approaches may be adopted to determine the frequency to phase ratio in different embodiments. For instance, additional attributes of the audio data may be analyzed to determine the frequency to phase ratio. Some exemplary approaches have been discussed above.

In some embodiments, the cosine/sine coefficients are divided by the magnitude to be two-dimensional unit vectors. Using the frequency to phase ratio determined for a window, all magnitudes in the window are scaled by the frequency to phase ratio determined to exaggerate frequency over phase. One exemplary Mcs representation of cosine/sine coefficient data is illustrated in FIG. 2D. As shown in FIG. 2D, the magnitudes Mᵢ are disproportionately represented over the cosine/sine coefficients cᵢ and sᵢ, where i ranges from 1 to N. The following transformation is applied to all input cosine/sine vectors to produce Mcs vectors prior to vector quantization:
1. Magnitude at bin j:

Mⱼ=\sqrt{|\vec{c}ⱼ|²+|\vec{s}ⱼ|²}
2. Revised cosine/sine coefficients at bin j:

$${c}_{j}^{′} = \frac{\vert {c}_{j} \vert}{{M}_{j}}$$

$${s}_{j}^{′} = \frac{\vert {s}_{j} \vert}{{M}_{j}}$$

3. Scale all magnitudes by the frequency to phase ratio S of the corresponding window to enhance the magnitudes:

Mⱼ′=SMⱼ

In some embodiments, the Mcs transformer 200 forwards the accumulation of transformed data in Mcs format to a vector quantizer, which applies vector quantization on the transformed data to generate a set of center vectors. After vector quantization, the Mcs transformer 200 may act as an inverse Mcs (iMcs) transformer to apply the following inverse transform to the center vectors:

1. Calculate phase angle at bin j:

Φⱼ=arctan 2(\vec{c}ⱼ′,\vec{s}ⱼ′)

2. Derive DCT cosine/sine coefficients:

\vec{c}ⱼ=Mⱼ′ cos(Φⱼ)S

\vec{s}ⱼ=Mⱼ′ sin(Φⱼ)S

3. Apply normalization to time-domain vector after applying inverse DCT (iDCT).

Note that the cosine/sine data is signed and may be positive or negative, whereas the magnitude is unsigned, as illustrated in FIG. 2D. In vector quantization, clusters of points are found and then a point is computed to represent that cluster. This point is referred to as the representative point. In some embodiments, the representative point is computed by averaging the points representing the cluster. The cosine/sine data represents the frequency information for a specific frequency band. Within the cosine and the sine, the data contains both the magnitude and the phase information. In some embodiments, the magnitude is extracted and represented additionally, while the cosine and sine vectors represent the phase, in the Mcs format.

Without the Mcs format, vector quantization may destroy the magnitude because of the averaging. That is, the vector quantization process may cluster around the dimensions (cosine/sine values) with the greatest magnitude and the dimensions with lower magnitudes may get their magnitude vectors (i.e., the natural vector of the cosine/sine) squashed. For example, when averaging a set of random numbers between −N and N, where N is any real number, the result typically averages towards zero. In general, the cosine and sine data is randomly distributed between −N and N among the many input points, and so magnitude tends to get averaged down. Note that the cosine and sine data may not be perfectly even, and this results in the phase obtained from the vector quantization process. Since the phase is represented by the relative magnitudes of the two numbers and their signs, the phase information may survive averaging and can be extracted even if the individual values are squashed. If the phases of various original inputs in a cluster tend towards one phase, this will be the phase of the resulting vector quantization centroid in some embodiments. This is how some semblance of the original phase information may be preserved. Once the phase is recovered from the cosine/sine part, the phase may be combined with the magnitude to reconstitute the cosine and sine of the frequency domain data fed to an inverse Discrete Cosine Transform (DCT) process. More details of the post-vector quantization processing are discussed below with reference to FIG. 3.

Although, in some embodiments, there are many dimensions of vector space (such as 81), an example of three-dimensional space is discussed below to further illustrate the concept. In the current example, there is one tuple of Mcs data, where the points of the cluster are far along the magnitude axis (the “M axis”) because of the frequency-to-phase ratio, but otherwise equally distributed around that axis in the cosine and sine dimensions. The averaging in vector quantization may find a center point in the cluster that well represents the input points along the M axis because all the magnitudes are positive, but in the cosine and sine plane, the point may be nearer to (0, 0) because they are a mix of positive and negative numbers. The point may not be exactly (0, 0), so it may still have some phase information, but as discussed earlier, it does not matter what the magnitude of the vector in the cosine/sine plane is to get the phase since the phase is the angle of that vector from (0, 0).

In sum, the Mcs format helps to reduce distortion in magnitudes, and thus, improves the sound quality. Furthermore, the Mcs format does not only allow emphasis of frequency over phase, even if the frequency-to-phase ratio is set to 1.0 (i.e., the magnitude is not scaled up), the Mcs format still preserves the magnitude information that would otherwise be lost during vector quantization.

FIG. 3 illustrates one embodiment of a system to convert audio data into codebook waveforms. The system 300 includes a source of audio data 310, a DCT transformer 330, a Mcs transformer 340, a vector quantizer 350, an iMcs transformer 360, and an iDCT transformer 370. The source of audio data 310 may include a machine-readable storage medium embodying uncompressed encodings of audio data 320, such as a hard drive, a compact disk (CD), etc. In some embodiments, the audio data 320 includes pulse code modulated (PCM) data. The audio data 320 is typically divided into a set of windows (a.k.a. signal windows), which may be overlapping. From the source 310, the audio data 320 is forwarded to the DCT transformer 330.

In some embodiments, the DCT transformer 330 applies DCT to the audio data 320 to transform the audio data 320 into the frequency domain. After the DCT transform, the audio data is represented as a sum of cosine and sine functions. In some embodiments, the transformed audio data is represented as paired cosine/sine coefficients. The transformed audio data is then forwarded to the Mcs transformer 340. The Mcs transformer 340 transforms the audio data from a cosine/sine format into a magnitude/cosine/sine format. By adding additional magnitude bins to the audio data from the DCT transformer 330, the Mcs transformer 340 stretches the data along the magnitude dimensions such that the data may cluster more about frequency magnitudes than the cosine/sine phase coefficients. More details of some embodiments of a method and an apparatus to transform audio data into the Mcs format have been discussed above with reference to FIGS. 1 and 2.

After the audio data has been transformed into the magnitude/cosine/sine format, the audio data is forwarded to the vector quantizer 350. The vector quantizer 350 compresses the audio data by applying vector quantization to the audio data to generate center vectors. Vector quantization generally allows modeling of probability density functions by the distribution of the prototype vectors of the audio data. Because the audio data has been stretched along the magnitude dimensions by the Mcs transformer 340, the magnitudes may not be cancelled even if the input cosine/sine bins are out of phase. Thus, the frequency power of the audio data can be reproduced more accurately. In psychoacoustic terms, frequency is significantly more important than phase because accurate reproduction of frequency helps to reduce audible distortion of the codebook waveforms 380 eventually produced.

After vector quantization, the vector quantizer 350 forwards the resulting center vectors to the iMcs transformer 360. The iMcs transformer 360 may compute the phase angles of the center vectors and derive their DCT cosine/sine coefficients to convert the center vectors back into the frequency domain data. The frequency domain data is then forwarded to the iDCT transformer 370 be transformed into codebook waveforms 380. In some embodiments, normalization may be applied to time-domain vectors after applying iDCT.

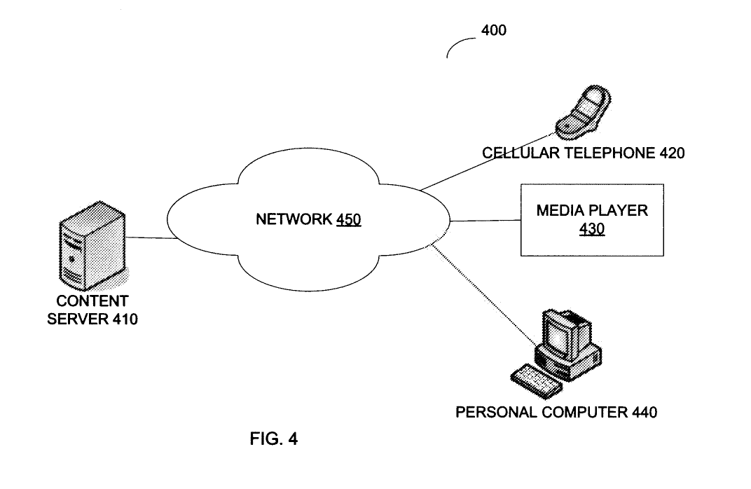

FIG. 4 illustrates one embodiment of a system in which the present invention may be implemented. The system 400 includes a content server 410, a cellular telephone 420, a media player 430, a personal computer 440, which are coupled to each other via a network 450. The network 450 may include various types of networks, such as a local area network (LAN), a wide area network (WAN), an intranet, the Internet, etc. Furthermore, the network 450 may include wired and/or wireless connections.

Note that any or all of the components of the system 400 and associated hardware may be used in various embodiments of the present invention. However, it can be appreciated that other configurations of the system 400 may include more or fewer devices than those discussed above. The content server 410, the cellular telephone 420, the media player 430, and the personal computer 440 are illustrative examples of machines communicatively coupled to the network 450. One should appreciate that other types of machines and/or devices may communicatively couple to the network 450 in other embodiments, such as a laptop computer, a personal digital assistant (PDA), a smart phone, etc.

In some embodiments, the content server 410 includes a DCT transformer, a Mcs transformer, a vector quantizer, an iMcs transformer, and an iDCT transformer. Using the DCT transformer, the content server 410 may transform audio data from time domain to frequency domain. Then the Mcs transformer may further transform the frequency domain data into magnitude/cosine/sine format. The vector quantizer applies vector quantization to the audio data in magnitude/cosine/sine format to generate a set of center vectors, which are transformed back into the frequency domain by the iMcs transformer. The iDCT transformer further transforms the frequency domain data into codebook waveforms. Details of some embodiments of the above operations to generate codebook waveforms have been discussed above with reference to FIGS. 1-3.

The content server 410 may store the codebook time domain waveforms locally. Alternatively, the content server 410 may send the codebook waveforms to other machines (e.g., the media player 430, etc.) via the network 450. Because the audio data has been converted into Mcs format before vector quantization, the magnitude in the data is disproportionately represented over phase. Thus, upon vector quantization, the center vectors resulted may cluster more about frequency magnitude than cosine/sine phase coefficients. Because frequency is more important than phase in psychoacoustic terms, the codebook waveforms generated using the above approach sounds more timbre-accurate.

FIG. 5 shows one embodiment of a computing system (e.g., a computer) for implementing some embodiments of the Mcs transformer of FIG. 2A. The exemplary computing system of FIG. 5 includes: 1) one or more processors 501; 2) a memory control hub (MCH) 502; 3) a system memory 503 (of which different types exist such as DDR RAM, EDO RAM, etc,); 4) a cache 504; 5) an I/O control hub (ICH) 505; 6) a graphics processor 506; 7) a display/screen 507 (of which different types exist such as Cathode Ray Tube (CRT), Thin Film Transistor (TFT), Liquid Crystal Display (LCD), DPL, etc.; and/or 8), and one or more I/O devices 508₁, 508₂, . . . , 508_{N} (such as keyboard, speakers, etc.).

The one or more processors 501 execute instructions in order to perform whatever software routines the computing system implements. The instructions frequently involve some sort of operation performed upon data. Both data and instructions are stored in system memory 503 and cache 504. Cache 504 is typically designed to have shorter latency times than system memory 503. For example, cache 504 might be integrated onto the same silicon chip(s) as the processor(s) and/or constructed with faster SRAM cells whilst system memory 503 might be constructed with slower DRAM cells. By tending to store more frequently used instructions and data in the cache 504 as opposed to the system memory 503, the overall performance efficiency of the computing system improves.

System memory 503 is deliberately made available to other components within the computing system. For example, the data received from various interfaces to the computing system (e.g., keyboard and mouse, printer port, LAN port, modem port, etc.) or retrieved from an internal storage element of the computing system (e.g., hard disk drive) are often temporarily queued into system memory 503 prior to their being operated upon by the one or more processor(s) 501 in the implementation of a software program. Similarly, data that a software program determines should be sent from the computing system to an outside entity through one of the computing system interfaces, or stored into an internal storage element, is often temporarily queued in system memory 503 prior to its being transmitted or stored.

The ICH 505 is responsible for ensuring that such data is properly passed between the system memory 503 and its appropriate corresponding computing system interface (and internal storage device if the computing system is so designed). The MCH 502 is responsible for managing the various contending requests for system memory 503 access amongst the processor(s) 501, interfaces and internal storage elements that may proximately arise in time with respect to one another.

One or more I/O devices 508₁, 508₂, . . . , 508_{N} are also implemented in a typical computing system. I/O devices generally are responsible for transferring data to and/or from the computing system (e.g., a networking adapter); or, for large-scale non-volatile storage within the computing system (e.g., hard disk drive). ICH 505 has bi-directional point-to-point links between itself and the observed I/O devices 508.

Embodiments of the invention may include various steps as set forth above. The steps may be embodied in machine-executable instructions, which cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, flash, magnetic or optical cards, or other type of media/machine-readable medium suitable for storing electronic instructions.

Thus, some embodiments of a method and an apparatus to encode audio data have been described. It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A computer-implemented method comprising:
transforming frequency domain data in a plurality of signal windows of an audio dataset from a cosine/sine format to a magnitude/cosine/sine format, which disproportionately represents a magnitude of the frequency domain data over a phase of the frequency domain data; and
applying vector quantization on the transformed data to produce at least one of a reduced representation set of magnitude/cosine/sine data and a codebook.

2. The method of claim 1, wherein transforming the frequency domain data in the plurality of signal windows of the audio dataset comprises:
stretching the frequency domain data along magnitude dimensions to make data to cluster more about frequency magnitudes than paired cosine/sine phase coefficients of the frequency domain data.

3. The method of claim 1, wherein transforming the frequency domain data in the plurality of signal windows of the audio dataset comprises:
scaling the magnitude of the frequency domain data in each of the plurality of signal windows by a respective frequency-to-phase ratio.

4. The method of claim 3, further comprising:
performing tonal analysis in each of the plurality of signal windows to determine the respective frequency-to-phase ratio.

5. The method of claim 4, wherein performing the tonal analysis in each of the plurality of signal windows comprises:
for each of the plurality of signal windows,
computing a spectral complexity, a spectral entropy, and a frequency peak to mean ratio in a respective signal window; and
setting the respective frequency-to-phase ratio to be substantially equal to a maximum of the spectral complexity, the spectral entropy, and the frequency peak to mean ratio.

6. The method of claim 3, wherein the respective frequency-to-phase ratio is a value selected from a range of real numbers greater than zero (0).

7. The method of claim 3, wherein at least two of the frequency-to-phase ratios of the plurality of signal windows are distinct from each other.

8. The method of claim 3, wherein the frequency-to-phase ratios of the plurality of signal windows are substantially the same.

9. A machine-readable storage medium storing executable program instructions which when executed by a data processing system cause the data processing system to perform a method comprising:
transforming frequency domain data in a plurality of signal windows of an audio dataset from a cosine/sine format to a magnitude/cosine/sine format, which disproportionately represents a magnitude of the frequency domain data over a phase of the frequency domain data; and
applying vector quantization on the transformed data to produce at least one of a reduced representation set of magnitude/cosine/sine data and a codebook.

10. The machine-readable storage medium of claim 9, wherein transforming the frequency domain data in the plurality of signal windows of the audio dataset comprises:
stretching the frequency domain data along magnitude dimensions to make data to cluster more about frequency magnitudes than paired cosine/sine phase coefficients of the frequency domain data.

11. The machine-readable storage medium of claim 9, wherein transforming the frequency domain data in the plurality of signal windows of the audio dataset comprises:
scaling the magnitude of the frequency domain data in each of the plurality of signal windows by a respective frequency-to-phase ratio.

12. The machine-readable storage medium of claim 11, wherein the method further comprises:
performing tonal analysis in each of the plurality of signal windows to determine the respective frequency-to-phase ratio.

13. The machine-readable storage medium of claim 12, wherein performing the tonal analysis in each of the plurality of signal windows comprises:
for each of the plurality of signal windows,
computing a spectral complexity, a spectral entropy, and a frequency peak to mean ratio in a respective signal window; and
setting the respective frequency-to-phase ratio to be substantially equal to a maximum of the spectral complexity, the spectral entropy, and the frequency peak to mean ratio.

14. The machine-readable storage medium of claim 11, wherein the respective frequency-to-phase ratio is a value selected from a range of real numbers greater than zero (0).

15. The machine-readable storage medium of claim 11, wherein at least two of the frequency-to-phase ratios of the plurality of signal windows are distinct from each other.

16. The machine-readable storage medium of claim 11, wherein the frequency-to-phase ratios of the plurality of signal windows are substantially the same.

17. An apparatus comprising:
a magnitude/cosine/sine (Mcs) transformer to transform frequency domain data in a plurality of signal windows of an audio dataset from a cosine/sine format to a magnitude/cosine/sine format, which disproportionately represents a magnitude of the frequency domain data over a phase of the frequency domain data; and
a vector quantization module to compress the transformed data to produce at least one of a reduced representation set of magnitude/cosine/sine data and a codebook.

18. The apparatus of claim 17, wherein the Mcs transformer stretches the frequency domain data along magnitude dimensions to make data to cluster more about frequency magnitudes than paired cosine/sine phase coefficients of the frequency domain data.

19. The apparatus of claim 17, wherein the Mcs transformer comprises:
a scaling module to scale the magnitude of the frequency domain data in each of the plurality of signal windows by a respective frequency-to-phase ratio.

20. The apparatus of claim 19, further comprising:
a tonal analysis module to perform tonal analysis in each of the plurality of signal windows to determine the respective frequency-to-phase ratio.

21. The apparatus of claim 20, wherein, for each of the plurality of signal windows, the tonal analysis module computes a spectral complexity, a spectral entropy, and a frequency peak to mean ratio in a respective signal window, and sets the respective frequency-to-phase ratio to be substantially equal to a maximum of the spectral complexity, the spectral entropy, and the frequency peak to mean ratio.

22. The apparatus of claim 19, wherein the respective frequency-to-phase ratio is a value selected from a range of real numbers greater than zero (0).

23. The apparatus of claim 19, wherein at least two of the frequency-to-phase ratios of the plurality of signal windows are distinct from each other.

24. The apparatus of claim 19, wherein the frequency-to-phase ratios of the plurality of signal windows are substantially the same.
